(19) United States
(12) Patent Application Publication
(10) Pub. No.: US 2010/0208777 A1
(43) Pub. Date: Aug. 19, 2010

(54) DISTRIBUTED ANTENNA SYSTEM USING GIGABIT ETHERNET PHYSICAL LAYER DEVICE

(75) Inventor: Ronald S. Ogaz, Los Gatos, CA (US)

Correspondence Address: FOGG & POWERS LLC, 5810 W 78TH STREET, SUITE 100, MINNEAPOLIS, MN, 55439, US

(73) Assignee: ADC Telecommunications, Inc., Eden Prairie, MN (US)

(21) Appl. No.: 12/372,319

(22) Filed: Feb. 17, 2009

(51) Int. Cl. H04B 1/38

(52) U.S. Cl. 375/219

(57) ABSTRACT

One embodiment is directed to a distributed antenna system for distributing radio frequency signals within a coverage area. The system comprises a first unit and a second unit that is communicatively coupled to the first unit using a gigabit ETHERNET compatible communication medium. The first unit and the second unit include respective non-ETHERNET compatible media control devices and respective ETHERNET compatible physical layer devices. The first unit receives radio frequency signals and generates a digital representation of the radio frequency signals. The first unit transmits at least a portion of the digital representation of the radio frequency signals to the second unit over the gigabit ETHERNET compatible communication medium. The second unit reconstructs analog radio frequency signals from the received digital representation of the radio frequency signals for radiation within the coverage area.

### BACKGROUND

One way that a wireless cellular service provider can improve the coverage provided by a given base station or group of base stations is by using a distributed antenna system (DAS). In a DAS, radio frequency (RF) signals are communicated between a host unit and one or more remote antenna units (RAUs). The host unit is communicatively coupled to one or more base stations, for example, where the host unit is directly connected to the base station using coaxial cabling or where the host unit communicates with the base station wirelessly (that is, “over the air” or “on frequency”) using a donor antenna and a bi-directional amplifier (BDA)). Downlink RF signals are received from the base station at the host unit. The host unit uses the downlink RF signals to generate a downlink transport signal for distributing to one or more of the RAUs. Each such RAU receives the downlink transport signal and reconstructs the downlink RF signals from the downlink transport signal and causes the reconstructed downlink RF signals to be radiated from at least one antenna coupled to or included in that RAU. A similar process is performed in the uplink direction. Uplink RF signals received at one or more RAUs are used to generate respective uplink transport signals that are transmitted from the respective RAUs to the host unit. The host unit receives and combines the uplink transport signals transmitted from the RAUs. The host unit reconstructs the uplink RF signals received at the RAUs and communicates the reconstructed uplink RF signals to the base station. In this way, the coverage of the base station can be expanded using the DAS. One or more intermediate devices (also referred to as “expansion hubs” or “expansion units”) can be placed between the host unit and the remote antenna units in order to increase the number of RAUs that a single host unit can feed and/or to increase the host-unit-to-RAU distance.

One type of DAS generates the downlink and uplink transport signals by down-converting the respective downlink and uplink RF signals to an intermediate frequency (IF) range that is suitable for transmission over copper media such as copper twisted-pair cabling such as ordinary CAT-5 cabling or CATV cabling (such as RG-59 or RG-6 cabling). In such an analog DAS, the down-converted IF signal is directly radiated over the twisted-pair or CATV cabling.

However, the amount of bandwidth that can be communicated over twisted-pair cabling (that is, CAT-5 or CAT-6) using such analog IF frequency translation techniques is relatively limited (typically limited to only about 35 MHz). As result, only a portion of a given cellular band (for example, the portion of a given cellular band that is licensed to a single wireless service provider) can be distributed over such media using analog frequency translation techniques. Such a DAS system is also referred to here as an “analog single-band DAS”.

If the RF frequency bands for multiple wireless service providers need to be distributed within a given coverage area, more than one such analog single-band DAS would need to be deployed. Alternatively, other types of “broadband” physical media (such as CATV cabling, coaxial cabling, or optical fibers) can be used. For example, in one such alternative DAS noted above, the analog IF frequency translation techniques described above are used to distribute multiple RF bands over CATV cabling. In another alternative DAS, received downlink and uplink RF signals are down-converted to IF signals, which are then digitized. The digitized IF is then framed and communicated over fiber or coaxial cable. However, as noted above, such multi-band DAS systems typically are not able to use twisted-pair cabling such as CAT-5 or CAT-6 cabling.

### SUMMARY

One embodiment is directed to a distributed antenna system for distributing radio frequency signals within a coverage area. The system comprises a first unit and a second unit that is communicatively coupled to the first unit using a gigabit ETHERNET compatible communication medium. The first unit and the second unit include respective non-ETHERNET compatible media control devices and respective ETHERNET compatible physical layer devices. The first unit receives radio frequency signals and generates a digital representation of the radio frequency signals. The first unit transmits at least a portion of the digital representation of the radio frequency signals to the second unit over the gigabit ETHERNET compatible communication medium. The second unit reconstructs analog radio frequency signals from the received digital representation of the radio frequency signals for radiation within the coverage area.

Another embodiment is directed to a host unit for distributing analog downlink radio frequency signals within a coverage area. The host unit comprises a down-mixer to downconvert the analog downlink radio frequency signals to analog downlink intermediate frequency signals and an analog-to-digital converter to generate a digital representation of the analog downlink radio frequency signals by digitizing the analog downlink intermediate frequency signals. The host unit further comprises a non-ETHERNET compatible media access control device to frame the digital representation of the analog downlink radio frequency signals, and a gigabit ETHERNET physical layer device to transmit the framed digital representation of the analog downlink radio frequency signals to a remote antenna unit that is communicatively coupled to the host unit using a gigabit ETHERNET compatible communication medium. The gigabit ETHERNET physical layer device transmits the framed digital representation of the analog downlink radio frequency signals on the gigabit ETHERNET compatible communication medium to the remote antenna unit for use by the remote antenna unit in reconstructing the analog downlink radio frequency signals from the received framed digital representation of the downlink radio frequency signals for radiation within the coverage area.

Another embodiment is directed to a remote antenna unit for use in distributing analog downlink radio frequency signals within a coverage area. The remote antenna unit comprises a gigabit ETHERNET physical layer device to receive a framed digital representation of the analog downlink radio frequency signals from an Ethernet compatible communication medium. A host unit is coupled to the ETHERNET compatible communication medium. The host unit receives the analog downlink radio frequency signals and generates the framed digital representation of the analog downlink radio frequency signals. The remote antenna unit further includes a non-ETHERNET compatible media access control device to extract the digital representation of the analog downlink radio frequency signals from the framed digital representation of the analog downlink radio frequency signals. The remote antenna unit further comprises a digital-to-analog converter to reconstruct analog downlink intermediate frequency signals from the digital representation of the downlink radio frequency signals and an up-mixer to upconvert the reconstructed analog downlink intermediate frequency signals in order to produce reconstructed analog downlink radio frequency signals. The reconstructed analog downlink radio frequency signals are radiated from an antenna coupled to the remote antenna unit.

Another embodiment is directed to a first unit for distributing analog radio frequency signals to a second unit. The first unit comprises a non-ETHERNET compatible media control device and a gigabit ETHERNET compatible physical layer device. The first unit is communicatively coupled to the second unit using a gigabit ETHERNET compatible communication medium. The first unit receives the analog radio frequency signals and generates a digital representation of the analog radio frequency signals. The first unit transmits the digital representation of the analog radio frequency signals to the second unit over the gigabit ETHERNET compatible communication medium for use by the second unit in reconstructing analog radio frequency signals from the received digital representation of the analog radio frequency signals. The digital representation of the analog radio frequency signals is transmitted from the first unit to the second unit over the gigabit ETHERNET compatible communication medium using the non-ETHERNET media access control device and the gigabit ETHERNET compatible physical layer device.

Another embodiment is directed to a method of distributing radio frequency signals within a coverage area. The method comprises generating a digital representation of analog radio frequency signals and framing the digital representation of the analog radio frequency signals using a first non-ETHERNET compatible media access control device in order to produce a framed digital representation of the analog radio frequency signals. The method further comprises transmitting the framed digital representation of the analog radio frequency signals over a gigabit ETHERNET compatible communication medium using a first gigabit ETHERNET compatible physical layer device.

The details of various embodiments of the claimed invention are set forth in the accompanying drawings and the description below. Other features and advantages will become apparent from the description, the drawings, and the claims.

### DRAWINGS

FIGS. 1, 2A, and 2B are block diagrams of one embodiment of a distributed antenna system for distributing radio frequency signals within a coverage area.

FIGS. 3A-3B are flow diagrams of one embodiment of a method of distributing radio frequency (RF) signals within a coverage area.

FIG. 4A is a block diagram of an alternative embodiment of a host unit for use in a distributed antenna system.

FIG. 4B is a block diagram of an alternative embodiment of a remote antenna unit for use in a distributed antenna system.

FIG. 5 is a block diagram of one embodiment of a distributed antenna system for distributing radio frequency signals within a coverage area.

Like reference numbers and designations in the various drawings indicate like elements.

### DETAILED DESCRIPTION

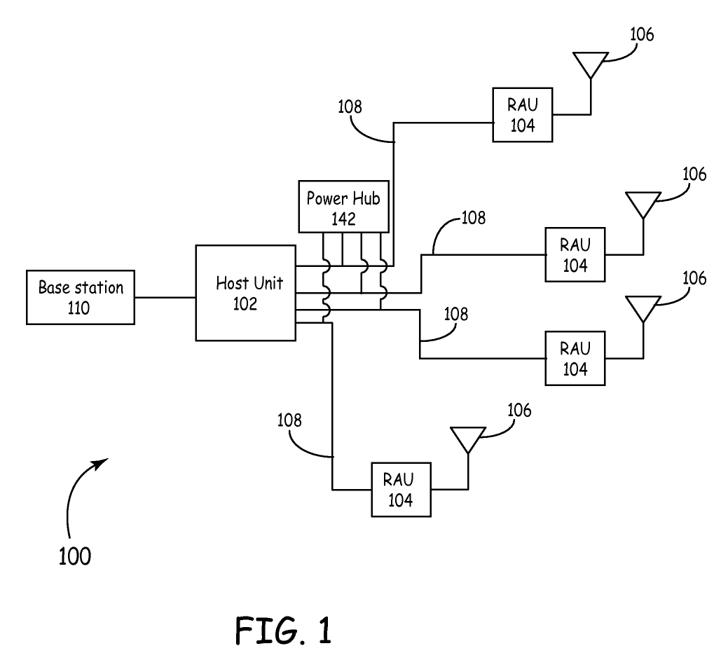

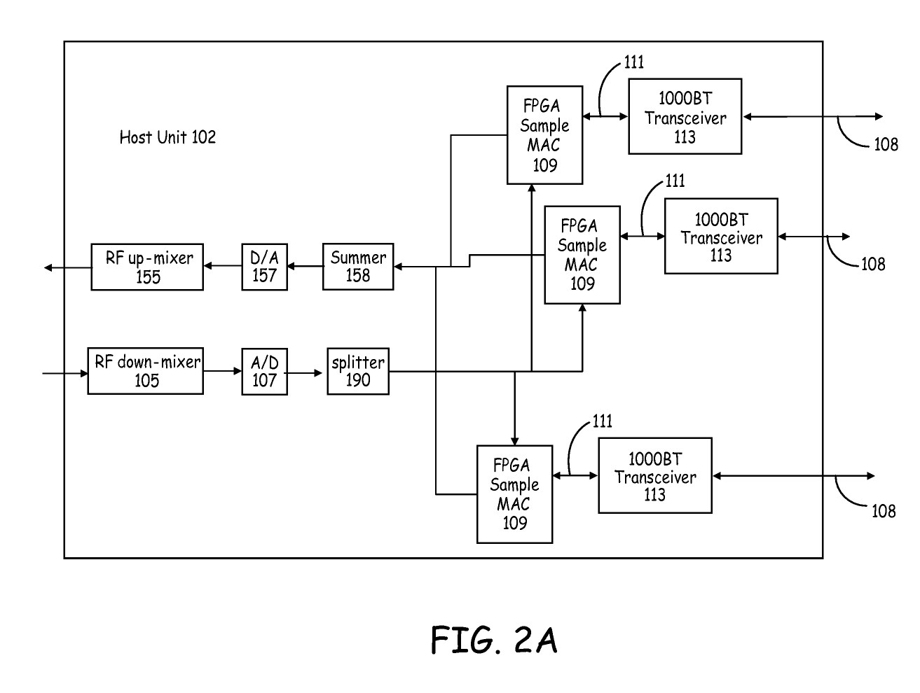

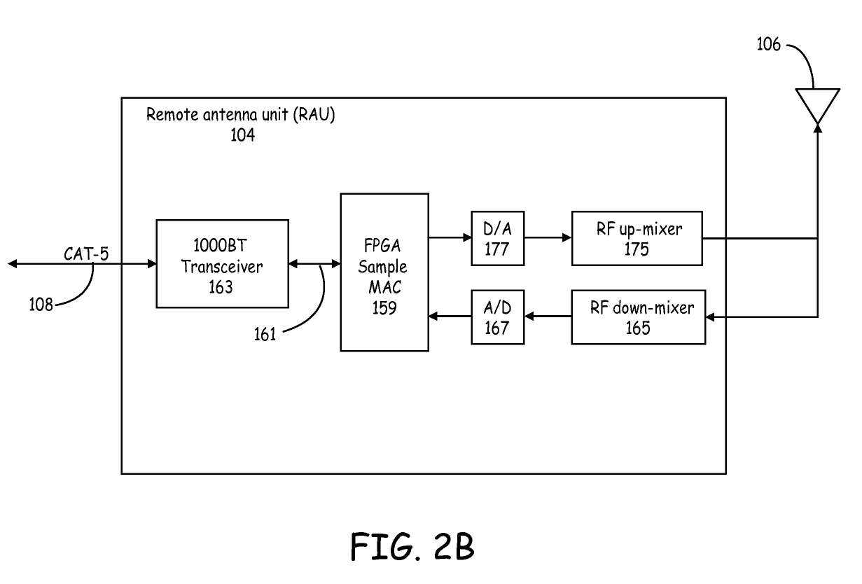

FIGS. 1, 2A, and 2B are block diagrams of one embodiment of a distributed antenna system (DAS) 100 for distributing radio frequency (RF) signals within a coverage area. In the particular embodiment shown in FIG. 1, the DAS 100 is configured to distribute one RF band (also referred to here as the “downlink RF band”) in the downlink direction and one RF band in the uplink direction (also referred to here as the “uplink RF band”). The downlink RF band and uplink RF band include respective portions of a single cellular RF band (for example, downlink and uplink portions of the GSM-850 or GSM-1900 bands) or the entire downlink and uplink bands for a single cellular band (for example, the entire downlink and uplink bands of the GSM-850 or GSM-1900 bands). In other embodiments, the DAS 100 is configured to distribute multiple RF bands, other cellular bands (such as other 2G, 3G or 4G voice and/or data bands), and/or other wireless spectrum (for example, unlicensed wireless spectrum that is used for implementing the Institute of Electrical and Electronics Engineers (IEEE) 802.11 family of wireless protocols or licensed spectrum that is used for implementing the IEEE 802.16 family of standards).

The DAS 100 comprises a host unit 102 and at least one (shown in FIG. 1 as multiple) remote antenna units (RAUs) 104. The RAUs 104 are located remotely from the host unit 102. For example, in one implementation where the DAS 100 is used in an in-building application, the host unit 102 is located in a central location (such as an equipment closet) and the RAUs 104 are located at various points throughout the building (for example, by mounting the RAUs 104 in the ceiling). The host unit 102 is also referred to herein as a “first unit 102.” The RAUs 104 are also referred to herein as “second units 104.”

Each of the RAUs 104 includes, or is coupled to, one or more remote antennas 106. Also, each of the RAUs 104 is communicatively coupled to the host unit 102 over a respective Gigabit ETHERNET compatible communication medium or media 108. Examples of Gigabit ETHERNET compatible cabling include 1000 BASE-CX balanced copper cabling, 1000 BASE-LX single-mode optical fiber, multi-mode fiber 1000 BASE-SX multi-mode optical fiber using 850 nm wavelength, 1000 BASE-LH single-mode or multi-mode optical fiber, 1000 BASE-ZX single-mode optical fiber, 1000 BASE-LX10 single-mode optical fiber, 1000 BASE-BX10 single-mode optical fiber, 1000 BASE-T twisted-pair cabling (such CAT-5, CAT-5e, CAT-6, or CAT-7 copper cabling), and 1000 BASE-TX twisted-pair cabling (such as CAT-6 and CAT-7 copper cabling). It is noted, however, that the lower cost of CAT-5, CAT-5e, and CAT-6 cabling and associated Gigabit ETHERNET physical layer devices make such cabling and physical layer devices especially well-suited for applications where lower cost is especially important, such as in-building applications. The particular embodiment shown in FIGS. 1, 2A and 2B is described here as being implemented using 1000 BASE-TX twisted-pair cabling.

The host unit 102 (first unit 102) is also communicatively coupled to one or more base stations 110 (or other wireless device such as an IEEE 802.11 or IEEE 802.16 wireless access point). In some implementations of such an embodiment, the host unit 102 is directly connected to the one or more base stations 110 with which it communicates (for example, via coaxial cabling). In other implementations of such an embodiment, the host unit 102 communicates with the one or more base stations 110 via a wireless communication link (for example, where the host unit 102 is coupled to a donor antenna via a bi-directional amplifier, which is used to amplify RF signals that are radiated and received using a donor antenna).

Also, power can be supplied to the RAU's 104 using conventional “Power over Ethernet” techniques specified in the IEEE 802.3af standard, which is hereby incorporated herein by reference. In such an implementation, a power hub 142 or other power supplying device is associated with the host unit 102. Typically, the power hub 142 is located near the host unit 102 or is incorporated into the host unit 102. The power hub 142 is coupled to each Gigabit ETHERNET compatible communication medium or media 108. An interface (not shown) picks the injected DC power off of the power wires and uses the picked-off power to power the RAUs 104. Using two twisted-pairs of the CAT5 it is possible to provide 35 Watts to the RAUs 104, which is sufficient for the approximately 3 Watts. estimated to be needed for the digital pats in art RAU 104. Using all four CAT5 twisted-pairs, the power supply can be increased to 70 Watts.

FIG. 2A is a block diagram of one embodiment of a host unit 102 in the DAS 100 of FIG. 1. The host unit 102 includes a radio frequency (RF) down-mixer 105, a radio frequency (RF) up-mixer 155, an analog-to-digital converter 107, a digital-to-analog converter 157, a splitter 190, and a summer 158. The host unit 102 also includes, for each RAU 104, a respective non-ETHERNET media access control device 109 (each of which is shown in FIG. 2A as a FPGA Sample MAC) and a respective Gigabit ETHERNET physical layer device 113 (also referred to here as a “Gigabit transceiver” 113). Each Gigabit transceiver 113 includes a respective media independent interface 111, which is used to communicatively couple that Gigabit transceiver 113 to the respective non-ETHERNET media access control device 109. When only one RAU is communicatively coupled to the host unit 102, the summer 158, and the splitter 190 are not required in the host unit 102.

FIG. 2B is a block diagram of one embodiment of a RAU 104 (second unit 104) in the DAS 100 of FIG. 1. The RAU 104 includes a Gigabit transceiver 163, a non-ETHERNET media access control device 159, a digital-to-analog converter 177, an analog-to-digital converter 167, a radio frequency (RF) up-mixer 175, and a radio frequency (RF) down-mixer 165. The Gigabit transceiver 163 is typically implemented using the same type of Gigabit transceiver as the Gigabit transceiver 113 of the host unit 163. The Gigabit transceiver 163 also includes a media independent interface 161 to that is used to couple the Gigabit transceiver 163 to the non-ETHERNET media access control device 159.

The host unit 102 and each of the RAUs 104 include an automatic gain control function (not shown) that is used to adjust the input power of the downlink and uplink RF signals received at the host unit 102 and the RAUs 104, respectively. For example, in one implementation of such an embodiment, a power detector is integrated into the FPGAs used to implement the non-ETHERNET media access control devices 109 and 159, which outputs a control signal that is used to adjust a respective digital variable-gain amplifier (DGA). The automatic gain control function is used to maximize the spurious free dynamic range (SFDR) of the analog-to-digital converter 107 in the host unit 102 and the analog-to-digital converters 167 in the RAUs 104.

The DAS 100 may include one or more of the following: filtering, amplification, duplexing, synchronization, and monitoring functionality as needed and as is known in the art.

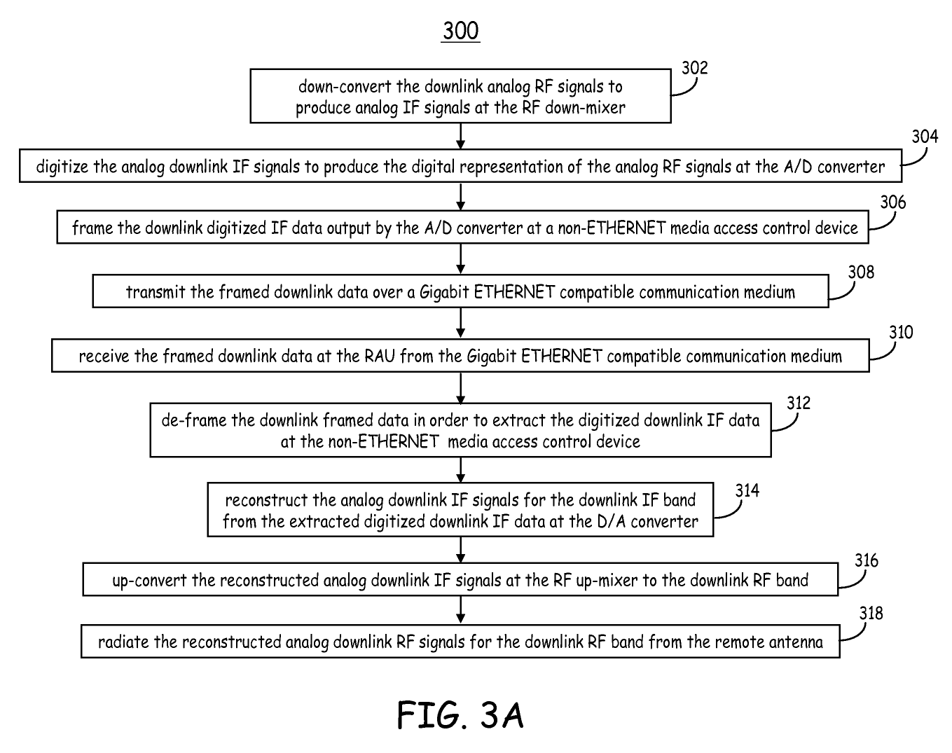

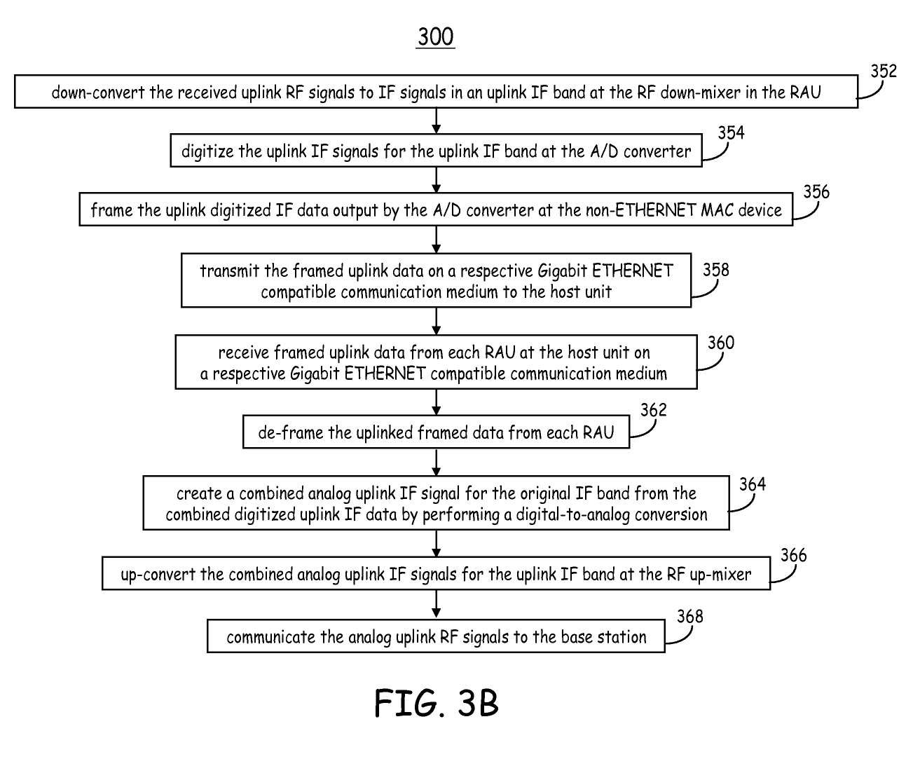

The operation of the DAS 100 of FIGS. 1, 2A, and 2B is described here in connection with FIGS. 3A and 3B. FIGS. 3A-3B are flow diagrams of one embodiment of a method 300 of distributing radio frequency (RF) signals within a coverage area. The embodiment of method 300 is described as being implemented using the DAS 100 described above in connection with FIGS. 1, 2A and 2B, though other embodiments are implemented in other ways. FIG. 3A illustrates the operation in the downlink direction (that is, from the host unit 102 to the RAUs 104), and FIG. 3B illustrates the operation in the uplink direction (that is, from each RAU 104 to the host unit 102).

The base stations 110 transmit downlink RF signals that include the particular downlink RF band to be distributed using the DAS 100. The downlink RF signals are received at the host unit 102. The RF down-mixer 105 down-converts the analog downlink RF signals for that RF band to intermediate frequency (IF) signals within a downlink IF band (block 302). The analog-to-digital converter 107 digitizes the analog downlink IF signals for the downlink IF band (block 304). The output of the analog-to-digital converter 107 is also referred to here as “downlink digitized IF data” or a “digital representation of the downlink radio frequency signals” and comprises a series of samples of the downlink IF signals. The output of the analog-to-digital converter 107 is split at the splitter 190 so the output is sent to each non-ETHERNET media access control device 109. Each non-ETHERNET media access control device 109 frames the downlink digitized IF data output by the A/D 107 (block 306). The framed downlink data output by each of the non-ETHERNET media access control devices 109 is communicated to respective Gigabit transceivers 113 over the respective media independent interface 111. Each Gigabit transceiver 113 transmits the framed downlink data on a respective Gigabit ETHERNET compatible communication medium 108 to the respective RAU 104 that is coupled to that medium 108 (block 308).

The framed downlink data is received at each RAU 104 from the respective Gigabit ETHERNET compatible communication medium 108 (block 310). The Gigabit transceiver 163 forwards the received downlink framed data to the non-ETHERNET media access control device 159 included in that RAU 104 via the media independent interface 161. The non-ETHERNET media access control device 159 de-frames the downlink framed data in order to extract the digitized downlink IF data (block 312). The digital-to-analog converter 177 reconstructs the analog downlink IF signals for the downlink IF band from the extracted digitized downlink IF data (block 314). The reconstructed analog downlink IF signals are up-converted by the RF up-mixer 155 to the downlink RF band on which the downlink RF signals were originally received at the host unit 102 (block 316). The reconstructed analog downlink RF signals for the downlink RF band are then radiated from the remote antenna 106 (block 318).

FIG. 3B shows the processing that is performed in the uplink direction. Mobile devices within the coverage area of each RAU 104 transmit uplink RF signals within the particular uplink RF band that is distributed by the DAS 100. The transmitted uplink RF signals are received at the RAU 104 via its remote antenna 106. The RF down-mixer 165 in the RAU 104 down-converts the received uplink RF signals to intermediate frequency (IF) signals with an uplink IF band (block 352). The analog-to-digital converter 167 digitizes the uplink IF signals for the uplink IF band (block 354). The output of the analog-to-digital converter 167 is also referred to here as “uplink digitized IF data” or “digital representation of the uplink radio frequency signals” and comprises a series of samples of the uplink IF signals. The non-ETHERNET media access control device 159 frames the uplink digitized IF data output by the A/D 167 (block 356). Typically, the frames that will include overhead data in addition to uplink digitized data. This overhead data can include identification data, error-detection and correction data (for example, parity and/or cyclic redundancy check (CRC) data), and synchronization data. This overhead data can also include a data link embedded in the frame structure to allow control of the RAU 104 (e.g., output power control, configuration control registers, LEDs) and to send status information to or from the RAU 104 (e.g., temperature, power supplies monitor, power output measurement). In one implementation of this embodiment, upgraded FPGA firmware is downloaded via an embedded data link to the RAU 104, to fix error in the RAU 104 or to add new capabilities.

The framed uplink data is communicated to the Gigabit transceiver 163 in that RAU 104 over the media independent interface 161. The Gigabit transceiver 163 transmits the framed uplink data on a respective Gigabit ETHERNET compatible communication medium 108 to the host unit 102 (block 358).

Framed uplink data from each of the RAUs 104 is received at the host unit 102 on a respective Gigabit ETHERNET compatible communication media 108 (block 360). Each Gigabit transceiver 113 forwards the received uplink framed data to the respective non-ETHERNET media access control device 109 via the respective media independent interface 111. The non-ETHERNET media access control device 109 de-frames the uplink framed data from each of the RAUs 104 (block 362). The summer 158 combines the extracted digitized uplink IF data. In one implementation of this embodiment, the extracted digitized uplink IF data is combined by digitally summing the digital samples produced by all of the RAUs 104 for each sample period. That is, in such an implementation, for each sample period, the respective IF samples produced by the respective A/Ds 167 in the RAUs 104 are added to together (with suitable overflow control to keep the sum within the number of bits supported by the digital-to-analog convertor 107 in the host unit 102). The digital-to-analog converter 107 then creates a combined analog uplink IF signal for the original IF band from the combined digitized uplink IF data by performing a digital-to-analog conversion (block 364). The combined analog uplink IF signals for the uplink IF band are up-converted by the RF up-mixer 155 to the uplink RF frequency band that was received at each of the RAUs 104 (block 366). The analog uplink RF signals are then communicated to the base stations 110 (block 368).

As noted above, the particular embodiment shown in FIGS. 1, 2A and 2B is implemented using 1000 BASE-TX twisted-pair cabling such as CAT-5. In such an embodiment, the Gigabit ETHERNET transceivers 113 and 163 use the signal processing techniques described in the Gigabit ETHERNET standards to communicate in both directions using all four pairs of each cable. These signal processing techniques are used to increase the amount of bandwidth that can be communicated over CAT-5, CAT-5e, or CAT-6 copper cabling.

The DAS 100 is implemented using point-to-point Gigabit ETHERNET links. Therefore, since there is only one transmitter in each direction on each link, there is no need to share the Gigabit ETHERNET physical layer 113 among multiple possible transmitters. Therefore the multiple-access techniques that are normally used in an ETHERNET MAC device (for example, carrier sense multiple access with collision detection (CSMA/CD)) are not needed. This is advantageous since the multiple-access techniques that are normally used in an ETHERNET MAC device may actually increase latency, which is undesirable in a DAS. In other words, by using a simpler non-ETHERNET MAC device, the cost, complexity, latency, and other overhead associated with ETHERNET MAC devices can be avoided.

In one implementation of this embodiment, one or both of the media independent interface 111 and the media independent interface 161 in the host unit 102 and each RAU 104, respectively, are Gigabit ETHERNET media independent interfaces (GMII). The Gigabit media independent interface can operate at speeds up to 1000 Mbit/s. In one implementation of this embodiment, the GMII is implemented using an eight bit data interface clocked at 125 MHz, and is backwards compatible with the media independent interface (MII) specification. It can also operate on fall-back speeds of 10/100 Mbit/s as per the MII specification Data on the GMII is framed using the IEEE ETHERNET standard. As such, it consists of a preamble, start of frame delimiter, ETHERNET headers, protocol specific data and a cyclic redundancy check (CRC) checksum. The GMII interface is defined in IEEE Standard 802.3, 2000 Edition.

In another implementation of this embodiment, one or both of the media independent interfaces are Gigabit ETHERNET reduced media independent interfaces (RMII). Reduced media independent interface is a standard that addresses the connection of ETHERNET physical layer transceivers to ETHERNET switches. RMII reduces the number of signals/pins required for connecting to the physical layer from 16 signals/pins (for an MII-compliant interface) to between 6 and 10 signals/pins. RMII is capable of supporting 10 and 100 Mbit/s. To be operable in DAS 100, the RMII needs a wider interface to perform at Gigabit speeds.

In yet another implementation of this embodiment, the non-ETHERNET media access control devices 109 and/or 159 165 in the host unit 102 and the RAU 104, respectively, are commercial off-the-shelf (COTS) products. In yet another implementation of this embodiment, the non-ETHERNET media access control devices 109 and/or 159 are FPGA baseband sample MACs and the Gigabit transceivers 113 and/or 163 are an ETHERNET 1000 T line interface units (LIUs). For example, than ETHERNET 1000 T line interface unit can be a Gig PHYTER V 10/100/1000 ETHERNET Physical Layer (model number DP83865), which is available from National Semiconductor.

The DAS 100 as shown in FIG. 1 is capable of one (1) Gigabit per second, full duplex, data sample transmission over about 90 meters with the four conductor pairs of a single Gigabit ETHERNET compatible communication medium 108. In one implementation of this embodiment, the Gigabit transceivers 113 and 163 are each a Gigabit ETHERNET line interface unit that uses a digital signal processor (DSP), transmitter pre-emphasis, echo cancellation, and receiver equalization with forward error correction. In this embodiment, the Gigabit transceivers 113 and 163 have a 10-¹⁰ bit error rate.

When 16-bit samples are transmitted at 1 Gbps, the non-ETHERNET media access control devices 109 and 159 operate at a maximum sample rate of 62.5 Mega-samples-per-second (MSPS). This sample rate of 62.5 MSPS allows the DAS 100 to transfer a maximum IF bandwidth of approximately 30 MHz. The Gigabit transceivers 113 and 163 (for example, 1 G ETHERNET line interface units) support bi-directional, full duplex transmissions.

One possible simple frame format is shown in Table 1 below. Other frame formats are possible.

TABLE 1
An exemplary frame format

| | 16-bit word |
|---|---|
| Start of Frame | EFFE hex |
| 8-bit RAU address | F address, F |
| 8 bit data link | FdataF |
| Sample 1 | 15-bit sample, 1 |
| Sample 2 | 15-bit sample, 1 |
| Sample 3 | 15-bit sample, 1 |
| Sample 4 | 15-bit sample, 1 |
| . . . | 15-bit sample, 1 |
| Sample N | 15-bit sample, 1 |
| End of Frame | FFFE hex |

A local oscillator (not shown) provides a reference signal to the RF down-mixers 105 and to the RF up-mixers 155 in the host unit 102 and the RAU 104. Various techniques are known in the art for synchronizing the local oscillators to the RF down-mixers 105 and RF up-mixers 155. For a first example, a timing/clock reference for synchronization is included in the frames that are communicated. For another example, the host unit 102 and the RAU 104 are both locked to a common reference.

Moreover, in some embodiments, the delay between the host unit 102 and the various RAUs 104 is equalized so that the downlink RF signals are radiated at the substantially same time from all of the RAUs 104 and so that the framed uplink data is received at the host unit 102 from all of the RAUs 104 at substantially the same time so that corresponding samples in the digitized uplink IF data can be combined together at the same time.

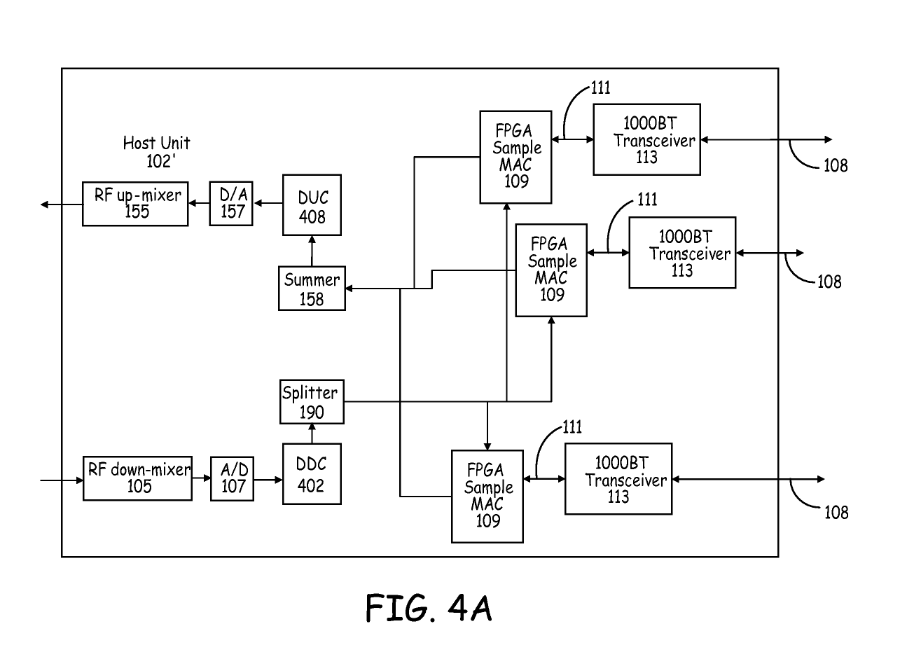

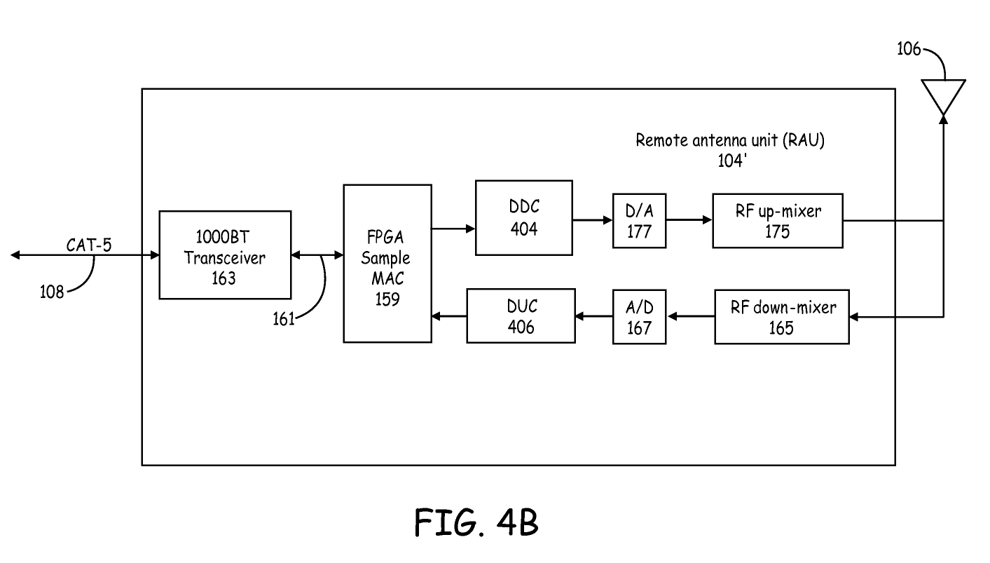

Although one exemplary embodiment of a DAS 100 is described above, it is to be understood that other embodiments can be implemented in other ways. For example, FIGS. 4A and 4B are block diagrams of one alternative embodiment of a distributed antenna system 100′. The DAS 100′ is similar to the DAS 100 of FIGS. 1, 2A-2B, and 3A-and 3B. Elements of the DAS 100′ that are substantially the same as corresponding elements in the DAS 100 are referenced in FIGS. 4A and 4B using the same reference numerals as is used in FIGS. 1, 2A and 2B, the description of which is not repeated here.

The main difference between the DAS 100′ and DAS 100 is the use of digital “tuners,” shown as digital down converter 402 and digital up converter 408 to select a particular RF band for distribution within the coverage area. Such an embodiment can be used to select the desired RF band to distributed using the DAS 100′ when the DAS 100′ is installed and/or configured.

As shown in FIG. 4A, the host unit 102′ (first unit 102′) comprises a digital down converter 402 that digitally filters and downconverts the downlink digitized IF data output by the analog-to-digital converter 107 so that the filtered downlink digitized IF data output to the splitter 190 only includes data for the desired downlink RF band. The filtered downlink digitized IF data is supplied to the non-ETHERNET MAC devices 109 for framing as described above. As shown in FIG. 4B, each RAU 104′ (second und 104′) also includes a digital down converter 404 that digitally filters and downconverts the downlink digitized IF data extracted by the non-ETHERNET MAC device 159 from the framed downlink data. This is done so that the filtered downlink digitized IF data only includes data for the desired downlink RF band.

Similar digital tuners are used in the uplink direction. As shown in FIG. 4B, each RAU 104′ comprises a digital up converter 406 that digitally filters and upconverts the uplink digitized IF data output by the analog-to-digital converter 167 so that the filtered uplink digitized IF data only includes data for the desired uplink RF band. The filtered uplink digitized IF data is supplied to the non-ETHERNET MAC devices 159 for framing as described above. As shown in FIG. 4A, the host unit 102′ also includes a digital up converter 408 that digitally filters and upconverts the uplink digitized IF data extracted by the non-ETHERNET MAC device 109 from the framed uplink data and summed by the summer 158. This is done so that the filtered uplink digitized IF data only includes data for the desired uplink RF band. In one implementation of this embodiment, there are plurality of digital up converters 408 associated with a respective one of the non-ETHERNET MAC devices 109 that each digitally filter the uplink digitized IF data extracted by the respective non-ETHERNET MAC device 109 prior to being summed at the summer 158.

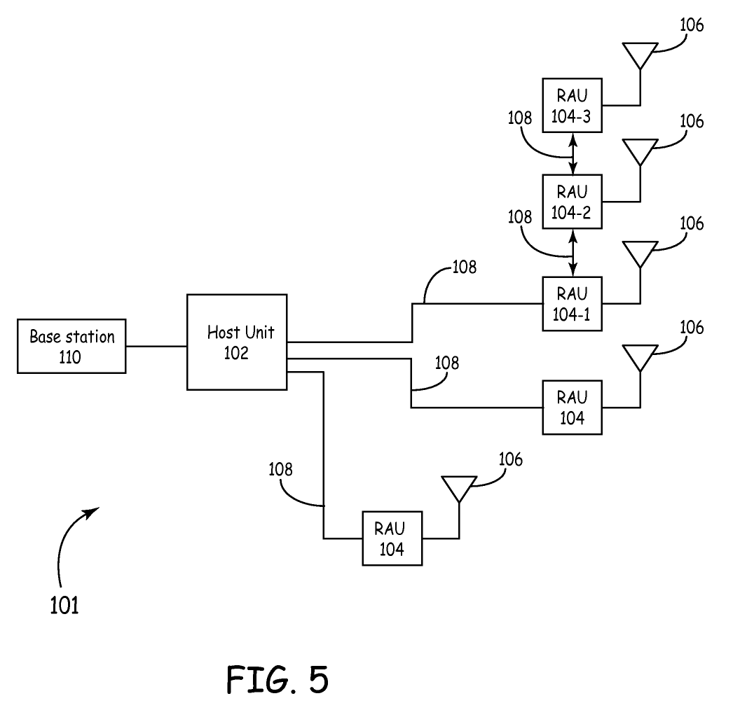

As is understandable to one skilled in the art, other topologies can be used to distributing radio frequency signals within a coverage area using respective Gigabit ETHERNET compatible communication medium or media 108. FIG. 5 is a block diagram of one embodiment of a distributed antenna system 101 for distributing radio frequency signals within a coverage area. In this daisy-chain topology, three of the RAU's 104(1-3) are daisy chained together. The daisy-chained RAUs 104 are extenders or repeaters in the distributed antenna system 101. In this distributed antenna system 101, the digital representation of the analog downlink radio frequency signals are passed to all the RAU's 104 and 104(1-3). The uplink RF signals from the RAU 104-3 is summed with the uplink samples from RAU 104-2, and then that summed uplink sample is summed with the uplink sample from RAU 104-1. In one implementation of this embodiment, the RAUs 104(1-3) include a digital up converter 406 (FIG. 4B) that is tuned to a different frequency range so the summed uplink signals do not overlap in the frequency spectrum. In this manner, the RAU's 104(1-3) share the uplink gigabit bandwidth.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A distributed antenna system for distributing radio frequency signals within a coverage area, the system comprising:
a first unit; and
a second unit communicatively coupled to the first unit using a gigabit ETHERNET compatible communication medium;
wherein the first unit and the second unit include respective non-ETHERNET compatible media control devices and respective ETHERNET compatible physical layer devices;
wherein the first unit receives radio frequency signals and generates a digital representation of the radio frequency signals;
wherein the first unit transmits at least a portion of the digital representation of the radio frequency signals to the second unit over the gigabit ETHERNET compatible communication medium; and
wherein the second unit reconstructs analog radio frequency signals from the received digital representation of the radio frequency signals for radiation within the coverage area.

2. The system of claim 1, wherein the reconstructed analog radio frequency signals are radiated from an antenna coupled to the second unit.

3. The system of claim 1:
wherein the radio frequency signals comprise downlink radio frequency signals;
wherein the second unit receives analog uplink radio frequency signals and generates a digital representation of the analog uplink radio frequency signals;
wherein the second unit transmits at least a portion of the digital representation of the analog uplink radio frequency signals to the first unit over the gigabit ETHERNET compatible communication medium; and
wherein the first unit reconstructs the analog uplink radio frequency signals from the digital representation of the analog uplink radio frequency signals.

4. The system of claim 1:
wherein the radio frequency signals comprise analog downlink radio frequency signals;
wherein the first unit comprises a host unit and the second unit comprises a remote antenna unit;
wherein the host unit further comprises:
a down-mixer to downconvert the analog downlink radio frequency signals to analog downlink intermediate frequency signals; and
an analog-to-digital converter to generate a digital representation of the analog downlink radio frequency signals by digitizing the analog downlink intermediate frequency signals;
wherein the non-ETHERNET compatible media access control device of the host unit frames the digital representation of the analog downlink radio frequency signals and the gigabit ETHERNET physical layer device transmits the framed digital representation of the analog downlink radio frequency signals to the remote antenna unit over the gigabit ETHERNET compatible communication medium;
wherein the gigabit ETHERNET physical layer device in the remote antenna unit receives the framed digital representation of the analog downlink radio frequency signals from the ETHERNET compatible communication medium and the non-ETHERNET compatible media access control device extracts the digital representation of the analog downlink radio frequency signals from the framed digital representation of the analog downlink radio frequency signals; and
wherein the remote antenna unit further comprises:
a digital-to-analog converter to reconstruct the analog downlink intermediate frequency signals from the digital representation of the downlink radio frequency signals; and
an up-mixer to upconvert the reconstructed analog downlink intermediate frequency signals in order to produce reconstructed analog downlink radio frequency signals; and
wherein the reconstructed analog downlink radio frequency signals are radiated from an antenna coupled to the remote antenna unit.

5. The system of claim 4, wherein the host unit further comprises a first digital down converter and the remote antenna unit comprises a second digital down converter, wherein the first digital down converter and the second digital down converter are used to digitally filter and downconvert the digital representation of the downlink radio frequency signals.

6. The system of claim 4:
wherein the remote antenna unit receives analog uplink radio frequency signals;
wherein the remote antenna unit further comprises:
a down-mixer to downconvert the analog uplink radio frequency signals to analog uplink intermediate frequency signals; and
an analog-to-digital converter to generate a digital representation of the analog uplink radio frequency signals by digitizing the analog uplink intermediate frequency signals;
wherein the non-ETHERNET compatible media access control device of the remote antenna unit frames the digital representation of the analog uplink radio frequency signals and the gigabit ETHERNET physical layer device transmits the framed digital representation of the analog uplink radio frequency signals to the host unit over the gigabit ETHERNET compatible communication medium;
wherein the gigabit ETHERNET physical layer device in the host unit receives the framed digital representation of the analog uplink radio frequency signals from the ETHERNET compatible communication medium and the non-ETHERNET compatible media access control device in the host unit extracts the digital representation of the analog uplink radio frequency signals from the framed digital representation of the analog uplink radio frequency signals; and
wherein the host unit further comprises:
a digital-to-analog converter to reconstruct the analog uplink intermediate frequency signals from the digital representation of the uplink radio frequency signals; and
an up-mixer to upconvert the reconstructed analog uplink intermediate frequency signals in order to produce reconstructed analog uplink radio frequency signals; and
wherein the reconstructed analog uplink radio frequency signals are communicated to at least one base station.

7. The system of claim 6, wherein the host unit further comprises a first digital up converter and the remote antenna unit comprises a second digital up converter, wherein the first digital up converter and the second digital up converter are used to digitally filter and upconvert the digital representation of the uplink radio frequency signals.

8. The system of claim 6, wherein the framed digital representation of the analog uplink radio frequency signals and the framed digital representation of the analog downlink radio frequency signals include overhead data.

9. The system of claim 8, wherein the overhead data comprises at least one of identification data, error-detection and correction data, and synchronization data.

10. The system of claim 8, wherein the overhead data includes a data link embedded in a frame structure to at least one of: control the remote antenna unit; download upgrades to the remote antenna unit; send status information to the remote antenna unit; and send status information from the remote antenna unit.

11. The system of claim 4, wherein the system comprises a plurality of remote antenna units, and wherein delay between the host unit and the plurality of remote antenna units is equalized.

12. The system of claim 4, wherein the host unit and the remote antenna unit implement automatic gain control.

13. The system of claim 4, wherein the host unit is communicatively coupled to at least one base station.

14. The system of claim 13, wherein the host unit is communicatively coupled to the at least one base station via at least one of a wired link and a wireless link.

15. The system of claim 4, wherein the system comprises a plurality of remote antenna units, wherein each of the plurality of remote antenna units is communicatively coupled to the host unit using a respective gigabit ETHERNET compatible communication medium;
wherein the host unit further comprises:
a plurality of non-ETHERNET compatible media access control devices;
a plurality of gigabit ETHERNET physical layer devices; and
a digital summer;
wherein each of the plurality remote antenna units receives respective analog uplink radio frequency signals and generates a respective digital representation of the respective analog uplink radio frequency signals received at that respective remote antenna unit;
wherein each of the plurality of remote antenna units transmits a respective framed digital representation of the respective analog uplink radio frequency signals to the host unit over the respective gigabit ETHERNET compatible communication medium; and
wherein the host unit, for each of the plurality of remote antenna units:
receives, from the respective gigabit ETHERNET compatible communication medium, the respective framed digital representation of the respective analog uplink radio frequency signals;
extracts, from the respective framed digital representation of the respective analog uplink radio frequency signals, the respective digital representation of the respective analog uplink radio frequency signals received at that respective remote antenna unit; and
digitally sums the digital representations of the analog uplink radio frequency signals received at the plurality of remote antenna units in connection with producing a combined analog uplink radio frequency signals.

16. The system of claim 15, wherein the host unit further comprises a first digital down converter and the plurality of remote antenna units each comprise a second digital down converter, wherein the first digital down converter and the second digital down converters are used to digitally filter and downconvert the digital representation of the downlink radio frequency signals.

17. The system of claim 16, wherein the host unit further comprises a first digital up converter and the plurality of remote antenna units each comprise a second digital up converter, wherein the first digital up converter and the second digital up converters are used to digitally filter and upconvert the digital representation of the uplink radio frequency signals.

18. The system of claim 15, wherein at least two of the plurality of remote antenna units are daisy chained, so that digital representation of the analog downlink radio frequency signals are passed to each of the daisy chained remote antenna units, and wherein uplink radio frequency signals from the daisy chained remote antenna units are summed.

19. The system of claim 4, further comprising:
a power hub associated with the host unit to couple power to each Gigabit ETHERNET compatible communication medium to power the remote antenna unit.

20. The system of claim 1, wherein the ETHERNET compatible physical layer device comprises an ETHERNET 1000 T line interface unit.

21. The system of claim 1, wherein the gigabit ETHERNET compatible communication medium comprises at least one of 1000 BASE-CX balanced copper cabling, 1000 BASE-LX single-mode optical fiber, multi-mode fiber 1000 BASE-SX multi-mode optical fiber using 850 nm wavelength, 1000 BASE-LH single-mode or multi-mode optical fiber, 1000 BASE-ZX single-mode optical fiber, 1000 BASE-LX10 single-mode optical fiber, 1000 BASE-BX10 single-mode optical fiber, 1000 BASE-T twisted-pair cabling, and 1000 BASE-TX twisted-pair cabling.

22. The system of claim 1, wherein the gigabit ETHERNET compatible communication medium comprises at least one of CAT-5 copper cabling, CAT-5e copper cabling, CAT-6 copper cabling, and CAT-7 copper cabling.

23. A host unit for distributing analog downlink radio frequency signals within a coverage area, the host unit comprising:
a down-mixer to downconvert the analog downlink radio frequency signals to analog downlink intermediate frequency signals;
an analog-to-digital converter to generate a digital representation of the analog downlink radio frequency signals by digitizing the analog downlink intermediate frequency signals;
a non-ETHERNET compatible media access control device to frame the digital representation of the analog downlink radio frequency signals; and
a gigabit ETHERNET physical layer device to transmit the framed digital representation of the analog downlink radio frequency signals to a remote antenna unit that is communicatively coupled to the host unit using a gigabit ETHERNET compatible communication medium; and
the gigabit ETHERNET physical layer device transmitting the framed digital representation of the analog downlink radio frequency signals on the gigabit ETHERNET compatible communication medium to the remote antenna unit for use by the remote antenna unit in reconstructing the analog downlink radio frequency signals from the received framed digital representation of the downlink radio frequency signals for radiation within the coverage area.

24. The host unit of claim 23, wherein the remote antenna unit receives analog uplink radio frequency signals, generates a digital representation of the analog uplink radio frequency signals, and transmits a framed digital representation of the analog uplink radio frequency signals to the host unit over the gigabit ETHERNET compatible communication medium;
wherein the gigabit ETHERNET physical layer device receives the framed digital representation of the analog uplink radio frequency signals from the ETHERNET compatible communication medium and the non-ETHERNET compatible media access control device extracts the digital representation of the analog uplink radio frequency signals from the framed digital representation of the analog uplink radio frequency signals; and
wherein the host unit further comprises:
a digital-to-analog converter to reconstruct analog uplink intermediate frequency signals from the digital representation of the uplink radio frequency signals; and
an up-mixer to upconvert the reconstructed analog uplink intermediate frequency signals in order to produce reconstructed analog uplink radio frequency signals; and
wherein the reconstructed analog uplink radio frequency signals are communicated to at least one base station.

25. The host unit of claim 24, further comprising:
a digital down converter to digitally filter and downconvert the digital representation of the downlink radio frequency signals; and
a digital up converter to digitally filter and upconvert the digital representation of the uplink radio frequency signals.

26. The host unit of claim 23, wherein the host unit is coupled to a plurality of remote antenna units, wherein each of the remote antenna units is coupled to the host unit using a respective gigabit ETHERNET compatible communication medium; and
wherein the host unit further comprises:
a plurality of non-ETHERNET compatible media access control devices;
a plurality of gigabit ETHERNET physical layer devices; and
a digital summer;
wherein each of the plurality remote antenna units receives respective analog uplink radio frequency signals and generates a respective digital representation of the respective analog uplink radio frequency signals received at that respective remote antenna unit;
wherein each of the plurality of remote antenna units transmits a respective framed digital representation of the respective analog uplink radio frequency signals to the host unit over the respective gigabit ETHERNET compatible communication medium;
wherein the host unit, for each of the plurality of remote antenna units:
receives, from the respective gigabit ETHERNET compatible communication medium, the respective framed digital representation of the respective analog uplink radio frequency signals; and
extracts, from the respective framed digital representation of the respective analog uplink radio frequency signals, the respective digital representation of the respective analog uplink radio frequency signals received at that respective remote antenna unit;
digitally sums the digital representations of the analog uplink radio frequency signals received at the plurality of remote antenna units in connection with producing a combined analog uplink radio frequency signals.

27. The host unit of claim 23, wherein the host unit is communicatively coupled to at least one base station.

28. The host unit of claim 27, wherein the host unit is communicatively coupled to the at least one base station via at least one of a wired link and a wireless link.

29. The host unit of claim 23, wherein the gigabit ETHERNET compatible communication medium comprises at least one of 1000 BASE-CX balanced copper cabling, 1000 BASE-LX single-mode optical fiber, multi-mode fiber 1000 BASE-SX multi-mode optical fiber using 850 nm wavelength, 1000 BASE-LH single-mode or multi-mode optical fiber, 1000 BASE-ZX single-mode optical fiber, 1000 BASE-LX10 single-mode optical fiber, 1000 BASE-BX10 single-mode optical fiber, 1000 BASE-T twisted-pair cabling, and 1000 BASE-TX twisted-pair cabling.

30. The host unit of claim 23, wherein the gigabit ETHERNET compatible communication medium comprises at least one of CAT-5 copper cabling, CAT-5e copper cabling, CAT-6 copper cabling, and CAT-7 copper cabling.

31. A remote antenna unit for use in distributing analog downlink radio frequency signals within a coverage area, the remote antenna unit comprising:
a gigabit ETHERNET physical layer device to receive a framed digital representation of the analog downlink radio frequency signals from a gigabit Ethernet compatible communication medium, wherein a host unit that is coupled to the gigabit ETHERNET compatible communication medium receives the analog downlink radio frequency signals and generates the framed digital representation of the analog downlink radio frequency signals;
a non-ETHERNET compatible media access control device to extract the digital representation of the analog downlink radio frequency signals from the framed digital representation of the analog downlink radio frequency signals;
a digital-to-analog converter to reconstruct analog downlink intermediate frequency signals from the digital representation of the downlink radio frequency signals; and
an up-mixer to upconvert the reconstructed analog downlink intermediate frequency signals in order to produce reconstructed analog downlink radio frequency signals; and
wherein the reconstructed analog downlink radio frequency signals are radiated from an antenna coupled to the remote antenna unit.

32. The remote antenna unit of claim 31, wherein the remote antenna unit receives analog uplink radio frequency signals; and
wherein the remote antenna unit further comprises:
a down-mixer to downconvert the analog uplink radio frequency signals to analog uplink intermediate frequency signals; and
an analog-to-digital converter to generate a digital representation of the analog uplink radio frequency signals by digitizing the analog uplink intermediate frequency signals;
wherein the non-ETHERNET compatible media access control device frames the digital representation of the analog uplink radio frequency signals; and
wherein the gigabit ETHERNET physical layer device transmits the framed digital representation of the analog uplink radio frequency signals to the host unit over the gigabit ETHERNET compatible communication medium for use by the host unit for use by the host unit in reconstructing the analog uplink radio frequency signals from the received framed digital representation of the uplink radio frequency signals.

33. The remote antenna unit of claim 32, further comprising:
a digital down converter to digitally filter and downconvert the digital representation of the downlink radio frequency signals; and
a digital up converter to digitally filter and upconvert the digital representation of the uplink radio frequency signals.

34. The remote antenna unit of claim 31, wherein the gigabit ETHERNET compatible communication medium comprises at least one of 1000 BASE-CX balanced copper cabling, 1000 BASE-LX single-mode optical fiber, multi-mode fiber 1000 BASE-SX multi-mode optical fiber using 850 nm wavelength, 1000 BASE-LH single-mode or multi-mode optical fiber, 1000 BASE-ZX single-mode optical fiber, 1000 BASE-LX10 single-mode optical fiber, 1000 BASE-BX10 single-mode optical fiber, 1000 BASE-T twisted-pair cabling, and 1000 BASE-TX twisted-pair cabling.

35. The remote antenna unit of claim 31, wherein the gigabit ETHERNET compatible communication medium comprises at least one of CAT-5 copper cabling, CAT-5e copper cabling, CAT-6 copper cabling, and CAT-7 copper cabling.

36. A first unit for distributing analog radio frequency signals to a second unit, the first unit comprising:
a non-ETHERNET compatible media control device;
a gigabit ETHERNET compatible physical layer device;
wherein the first unit is communicatively coupled to the second unit using a gigabit ETHERNET compatible communication medium;
wherein the first unit receives the analog radio frequency signals and generates a digital representation of the analog radio frequency signals;
wherein the first unit transmits the digital representation of the analog radio frequency signals to the second unit over the gigabit ETHERNET compatible communication medium for use by the second unit in reconstructing analog radio frequency signals from the received digital representation of the analog radio frequency signals, wherein the digital representation of the analog radio frequency signals is transmitted from the first unit to the second unit over the gigabit ETHERNET compatible communication medium using the non-ETHERNET media access control device and the gigabit ETHERNET compatible physical layer device.

37. The first unit of claim 36, wherein the reconstructed analog radio frequency signals are radiated from an antenna coupled to the second unit.

38. The first unit of claim 36:
wherein the analog radio frequency signals comprise analog downlink radio frequency signals;
wherein the second unit receives analog uplink radio frequency signals and generates a digital representation of the analog uplink radio frequency signals;
wherein the second unit transmits the digital representation of the analog uplink radio frequency signals to the first unit over the gigabit ETHERNET compatible communication medium;
wherein the first unit receives the digital representation of the analog uplink radio frequency signals using gigabit ETHERNET physical layer device; and
wherein the first unit reconstructs the analog uplink radio frequency signals from the digital representation of the analog uplink radio frequency signals using the non-ETHERNET compatible media access control device.

39. A method of distributing radio frequency signals within a coverage area, the method comprising:
generating a digital representation of analog radio frequency signals;
framing the digital representation of the analog radio frequency signals using a first non-ETHERNET compatible media access control device in order to produce a framed digital representation of the analog radio frequency signals; and
transmitting the framed digital representation of the analog radio frequency signals over a gigabit ETHERNET compatible communication medium using a first gigabit ETHERNET compatible physical layer device.

40. The method of claim 39, wherein generating the digital representation of the analog radio frequency signals comprises:
downconverting the analog radio frequency signals to produce analog intermediate frequency signals; and
digitizing the analog intermediate frequency signals in order to produce the digital representation of the analog radio frequency signals.

41. The method of claim 39, further comprising:
receiving the framed digital representation of the analog radio frequency signals from the gigabit ETHERNET compatible communication medium using a second gigabit ETHERNET compatible physical layer device;
extract the digital representation of the analog radio frequency signals from the framed digital representation of the analog radio frequency signals using a second non-ETHERNET compatible media access control device; and
reconstructing the analog radio frequency signals from the extracted digital representation of the analog radio frequency signals.

42. The method of claim 41,
wherein the digital representation of the analog radio frequency signals comprises a digital representation of analog intermediate frequency signals;
wherein reconstructing the analog radio frequency signals from the extracted digital representation of the analog radio frequency signals comprises:
digital-to-analog converting the digital representation of the analog intermediate frequency signals in order to produce reconstructed analog intermediate frequency signals; and
upconverting the reconstructed analog intermediate frequency signals to produce the reconstructed analog radio frequency signals.

43. The method of claim 39, wherein the framed digital representation of the analog radio frequency signals includes overhead data.

44. The method of claim 43, wherein the overhead data comprises at least one of identification data, error-detection and correction data, and synchronization data.

45. The method of claim 43, wherein the overhead data includes a data link embedded in a frame structure comprising: control data; upgrade data; and status information.
